(19) United States
(12) Patent Application Publication
(10) Pub. No.: US 2023/0024290 A1
(43) Pub. Date: Jan. 26, 2023

(54) ROTATING ELECTRICAL MACHINE

(71) Applicant: MOTEURS LEROY-SOMER, Angouleme Cedex 9 (FR)

(72) Inventors: Edouard BOMMÉ, Lyon (FR); Jlan ZHANG, Solaize (FR); Hanako FRIJLINK, Saint-Symphorien-d’Ozon (FR); Haikel GHERAIRI, Feyzin (FR)

(21) Appl. No.: 17/846,435

(22) Filed: Jun. 22, 2022

(30) Foreign Application Priority Data
Jul. 21, 2021 (FR) 21 07191

(51) Int. Cl. H02K 1/2781

(52) U.S. Cl. CPC H02K 1/2781

(57) ABSTRACT

A rotating electrical machine including a stator and a rotor having a rotor mass and permanent magnets, which are arranged on the surface of the rotor mass. The permanent magnets include a face which is directed towards the stator and is of a generally concave form. The permanent magnets of the rotor form poles of the rotor, in which the permanent magnet(s) of a same pole have an angular offset (a) between two longitudinal ends of the machine.

### TECHNICAL FIELD

The present invention relates to the field of rotating electrical machines, and more specifically but not exclusively those used for the motorisation of robots.

### BACKGROUND

The application EP 1 793 482 relates to a rotating electrical machine with reduced-load torque ripple which is intended to drive lift cars and comprises an external rotor which has substantially planar faces which are directed towards the stator.

Rotating electrical machines with an external rotor are also known, wherein the permanent magnets of the external rotor have a main face which is directed towards the stator and which has a cylindrical form generated by means of revolution.

In the case of an internal rotor, the main face of a magnet directed towards the stator is generally convex.

In the patent application FR 3 067 880, the permanent magnets comprise a concave face which comprises a concave portion. In this application, the magnets are straight.

In the patent U.S. Pat. No. 6,727,630, the surface of the magnets of the external rotor may be concave, being curved as a result of the positioning of the magnets on an external rotor.

The patent U.S. Pat. No. 6,727,629 teaches the reduction of the cogging using permanent magnets which are arranged in rings, the permanent magnets of adjacent rings being able to be offset relative to each other in the axial direction. Furthermore, the rotor is external and does not comprise any concave magnets. Finally, the stator comprises segments which may be offset.

Particularly in the field of motorisation of robots, it may be necessary to further reduce the magnetic cogging of a rotating electrical machine, in particular, for example, for a motor with permanent magnets which is controlled by a variable frequency drive. The magnetic cogging is also called cogging and corresponds to a torque ripple in the unloaded state or with a very low load.

There is therefore a need, in particular in the field of motorisation of robots, to provide rotating electrical machines with low torque ripple in the unloaded state or with a very low load.

### SUMMARY

The invention is intended to completely or partially meet this requirement and relates, according to one of its aspects thereof, to a rotating electrical machine, comprising:

a stator, and

a rotor comprising a rotor mass and permanent magnets arranged on the surface of the rotor mass,

the permanent magnets comprising a face which is directed towards the stator and which is generally concave, a concave face of a permanent magnet of the rotor comprising in particular a concave portion,
the permanent magnets of the rotor forming poles of the rotor, the permanent magnet(s) of a same pole having an angular offset between two longitudinal ends of the machine.

The rotor according to the invention enables a very low level of magnetic cogging without in any case impairing the overall performance levels of the machine, in particular the electromagnetic performance levels, the electromotive force and the torque inter alia.

It is thus possible to seek to minimise the torque ripples whilst obtaining a minimum peak torque to be reached, for a prefixed mechanical air gap.

Furthermore, the rotor has a better capacity to resist demagnetisation.

The presence of a generally concave face directed towards the stator for the permanent magnets of the rotor enables the torque ripples in the unloaded state or under very low load to be optimised.

In particular, the concavity of the permanent magnets enables the cogging to be reduced and more specifically the low-frequency harmonics, for example, the harmonics 16 and 18.

Furthermore, the angular offset enables in particular the high-frequency harmonics to be reduced.

Finally, the angular offset enables in particular the harmonics of the magnetic cogging to be eliminated, which the use of magnets with concavity could have a tendency to increase.

The angular offset being low, the electromagnetic performance levels of the motor, in particular the electromotive force, the torque, the power, are changed very little.

In this manner, it will be understood that there is a reinforcement effect in combining the concavity of the permanent magnets with the angular offset.

Rotor

The term “generally concave face” is intended to be understood to mean that the face of the permanent magnets of the rotor directed towards the stator has a curvature which provides it with a hollowed surface. The face may be entirely concave or may comprise one or more concave portions and one or more planar portions.

The presence of planar portions may enable interferences between the rotor and the stator to be better avoided.

The rotor mass may comprise a socket to which the permanent magnets are fixed, in particular by means of adhesive bonding.

The socket may be formed by a stack of metal sheets. The socket may be single, carrying all the permanent magnets of the rotor. In a variant, the rotor mass may comprise a plurality of sockets, for example, the same number as circumferential rows of permanent magnets.

The socket(s) may be fixed, for example, by means of adhesive bonding, to a shaft of the machine. The shaft may be smooth.

In one embodiment, each pole may comprise at least one twisted permanent magnet. Each pole may comprise a single twisted permanent magnet or, in a variant, a plurality. The term “twisted permanent magnet” is intended to be understood to mean that there is an angular offset between each of the two longitudinal ends of the permanent magnet.

The corresponding permanent magnet may be in a single piece.

The permanent magnets may, for example, be produced by means of moulding. In a variant, they may be machined.

The angular offset between each of the two longitudinal ends of the permanent magnet may be between 1° and 5°, preferably between 2.5° and 5°, or between 3° and 4.5°, even more preferably between 3.2° and 4°, being, for example, 3.5°.

In one variant, each pole may comprise a plurality of permanent magnets which are angularly offset relative to each other. Each pole may, for example, comprise two permanent magnets which are offset relative to each other by a specific angle.

In this manner, the rotor may comprise a plurality of circumferential rows of permanent magnets, for example, two circumferential rows. All the magnets of the same circumferential row may be fixed to the same socket mentioned above.

The rotor may comprise a plurality of assemblies composed of a socket and permanent magnets which are arranged in a circumferential row, for example, two assemblies, or three or four assemblies. All the assemblies may be identical. The machine may advantageously be composed of only one type of assembly, which are all identical, which enables the production costs to be reduced.

In one variant, the same socket may carry a plurality of circumferential rows of permanent magnets.

In this instance, the permanent magnets may be straight, that is to say, not twisted, or in a variant they may be twisted.

In one embodiment, the rotor may comprise at least two assemblies which are each composed of a socket and permanent magnets which are fixed to the socket and which are arranged in a circumferential row, the two assemblies being arranged symmetrically relative to each other relative to a transverse plane of the machine.

Such a configuration may enable the angular offset to be produced as a result of the overturning of one assembly relative to the other.

The angular offset may be obtained as a result of the fact that an assembly may comprise in the socket through-holes for rods in order to enable the socket(s) to be clamped around the shaft of the machine. The holes may be placed so that, when a socket is placed symmetrically relative to another socket, an angular offset is obtained between the permanent magnet which they carry.

The holes may be positioned below and at the centre of the magnet. In this manner, these holes do not interfere with the flux field lines of the corresponding magnet.

The assembly may comprise two holes, which are offset from each other by substantially 180°. These two holes may not be precisely in the axis of the centre of the magnet but instead offset by an angle which is equal to half of the angular offset, that is, for example, 0.625°.

Each socket may be identical. By overturning one of the two sockets through 180° about the X axis, the angular offset is generated between the sockets.

The angular offset between two consecutive magnets of the same pole may be between 0.8° and 2.5°, preferably between 1° and 2°, or between 1.1° and 1.7°, even more preferably between 1.20° and 1.5°, being, for example, 1.25°.

An angular offset between the first magnet and the last magnet of the same pole may be between 0.8° and 2.5°, preferably between 1° and 2°, or between 1.1° and 1.7°, even more preferably between 1.20° and 1.5°, being, for example, 1.25°.

The selection of an angular offset with quite a small angle may be sufficient to reduce the torque harmonics. In particular, the selection of the angle of angular offset may enable the harmonic 144 to be reduced. This is particularly advantageous in so far as the presence of concave magnets may bring about an increase of this harmonic 144.

The selection of an angle which is too large could involve the risk of bringing about a deterioration in the performance levels of the machine.

In one embodiment, the rotor may comprise 16 poles.

In one embodiment, the rotor may be internal. In this instance, the face of the magnets directed towards the stator corresponds to the face of the magnets opposite an rotation axis X of the machine.

In a variant, the rotor may be external, which may enable it in particular to rotate at a relatively high speed while limiting the risk of the magnets becoming disengaged. In this instance, the face of the magnets directed towards the stator corresponds to the face of the magnets directed towards the rotation axis X of the machine.

In the case of an external rotor, the concavity of the face directed towards the stator of the permanent magnets of the rotor is greater than a concavity which is solely provided by a cylindrical form of the face, which would result from the external arrangement of the rotor in order to enable the stator to be placed inside it and to provide a sufficient air gap between the rotor and the stator. In other words, the concavity of the faces directed towards the stator of the permanent magnets of the rotor is deeper than a cylindrical surface generated by means of revolution.

The shaft of the rotor may be massive, being, for example, hollow or solid.

In a variant it could not be massive, comprising, for example, a stack of laminated metal sheets. The metal sheets may each be covered with an insulating varnish in order to limit the losses from induced current.

A concave face of a permanent magnet of the rotor may comprise a concave portion. The width l of the concave portion, measured perpendicularly to a radius of the rotor, may be between 0.1π(D_{S}−2d)/P and 2π(D_{S}−2d)/P mm (millimetres),

where D_{S} is the bore diameter of the stator,

P is the number of poles of the rotor, and

d is the simple air gap, that is to say, the smallest width of the air gap.

The width l of the concave portion, measured perpendicularly to a radius of the rotor, may be between 2 and 56 mm, preferably between 4 and 40 mm, or between 8 and 20 mm, even more preferably between 8 and 12 mm.

A width of a permanent magnet of the rotor measured perpendicularly to the rotation axis is, for example, between 0.1π(D_{S}−2d)/P and 2π(D_{S}−2d)/P mm (millimetres).

The width of a permanent magnet of the rotor measured perpendicularly to the rotation axis is, for example, between 4 and 56 mm, preferably between 6 and 50 mm, or between 8 and 40 mm, even more preferably between 10 and 20 mm, being, for example, in the order of 19 mm.

The greatest depth p of the concavity of the concave portion, measured along a radius of the rotor, may be between 0.01 mm and the thickness h of the corresponding magnet, in particular between 0.05 and 3 mm.

The greatest depth of the concavity of the concave portion, measured along a radius of the rotor, may be located at the centre of the concave face of the corresponding permanent magnet. A permanent magnet is preferably symmetrical relative to a plane which intersects it at the centre thereof, this plane extending through the rotation axis of the machine and a radius of the rotor. In a variant, the greatest depth of the concavity of the concave portion, measured along a radius of the rotor, is located at a position other than at the centre of the concave face of the corresponding permanent magnet. A permanent magnet may not be symmetrical relative to a plane which intersects it at the centre thereof.

The concave portion may be a circle portion or an ellipse portion in cross section. The radius of the circle or the large axis of the ellipse may, for example, be between 0.1 h*, where h is the thickness of the magnet, and 100 h mm, in particular between 4 and 56 mm, more preferably between 6 and 40 mm, being, for example, in the order of 13 mm.

The concave portion of a concave face may be arranged between two planar lateral portions. The presence of planar lateral portions on the generally concave face enables an advantage to be derived from the concavity for the face of the magnets orientated towards the stator, whilst having a sufficient air gap between the rotor and the stator.

The width of a planar lateral portion measured perpendicularly to a radius of the rotor is, for example, between 0 and the width L of the magnet, preferably between 0.75 and 7 mm, being for example, in the order of 2 mm.

The concave portion may constitute from 20 to 100% of the total width of the corresponding magnet, preferably between 25 and 90%, or between 40 and 80%. In one embodiment, the concave portion constitutes 75% of the total width of the corresponding magnet. In another embodiment, in the absence of a planar lateral portion, the concave portion constitutes 100% of the total width of the corresponding magnet.

The permanent magnets of the rotor may have, when the machine is viewed along the rotation axis, a cross section of elongate form. In particular, the permanent magnets of the rotor may have, when the machine is viewed along the rotation axis of the rotor, a cross section of generally rectangular form having a large side which is orientated perpendicularly to a radius of the machine.

The permanent magnets of the rotor may have a thickness h, measured along a radius of the rotor, between 0.5 and 32 d, where d is the smallest width of the air gap, in particular between 1 and 20 mm, preferably between 1.5 and 10 mm, or between 2 and 5 mm.

A ratio p/h between the greatest depth of the concavity of the concave portion, measured along a radius of the rotor, and the thickness of a permanent magnet is, for example, between 0.01 and 0.9, preferably between 0.1 and 0.4.

The rotor and the stator provide an air gap between them. The air gap may have a width, measured along a radius of the machine, between 0.5 and 3 mm, preferably between 0.6 and 1.4 mm, being, for example, in the order of 0.9 mm. The air gap is preferably greater than 5/10 mm, preferably greater than 7/10 mm, in order to permit the rotation of the rotor in or about the stator.

The width d₀ of the air gap, measured along a radius which extends through the centre of a magnet, may be between 0.5 and 5 mm, preferably between 0.75 and 3 mm, being, for example, in the order of 1.6 mm. The air gap may be widest at the centre of a magnet, for the machine according to the invention, in so far as the concavity of the concave face of the magnet y is deepest.

The bore D_{R} of the rotor which corresponds to the external diameter of the rotor in the case of an internal rotor is, for example, between 15 and 150 mm, preferably between 20 and 120 mm, being, for example, in the order of 105 mm.

The magnets may or may not be monolithic. In one embodiment, a pole of the rotor is formed by a permanent magnet in a single block. In a variant, a pole of the rotor is formed by several magnets which may be arranged one after the other during movement along the rotation axis of the rotor.

The permanent magnets may be produced from ferrites, plasto-ferrites, rare earths or plasto rare earths, or AlNiCo.

The permanent magnets may be formed from a powder, then machined.

The remanent induction in the permanent magnets of a pole of the rotor may be between 0.2 Tesla and 1.8 Tesla, preferably between 0.3 Tesla and 1.5 Tesla, being, for example, in the order of 1.2 Tesla.

The permanent magnets of the rotor comprise a fixing face which is opposite the concave face and which is directed towards the stator. The fixing face may be planar. A planar face may facilitate the installation of the magnets on the rotor mass. In a variant, the fixing face could be convex, which enables the electromagnetic performance levels of the machine to be improved. The convexity of the fixing face may be directed towards the rotation axis in the case of an internal rotor or towards the outer side in the case of an external rotor which may enable the electromagnetic performance levels of the machine to be improved.

In the case of a planar face, the planar face is orientated perpendicularly to the radius which extends through the rotation axis and which intersects the corresponding magnet at mid-length.

The permanent magnets may be fixed to the rotor mass of the rotor by means of adhesive bonding, for example, on a cylindrical surface of the rotor mass or in a housing provided for this purpose on the surface of the rotor mass. In a variant, they may be crimped in a corresponding housing of the rotor mass. The housing may have a planar or concave surface in accordance with the shape of the fixing face of the magnets.

The rotor mass and/or the shaft of the rotor may be produced by stacking magnetic metal sheets.

Stator

The stator may have a concentrated winding. The stator may comprise teeth and coils which are arranged on the teeth. The stator may thus be wound on teeth, in other words with a non-distributed winding. In a variant, the stator could have a distributed winding.

The teeth of the stator may comprise pole shoes. In a variant, the teeth of the state could not have pole shoes.

The opening of the notches of the stator, measured circumferentially, between the pole shoes, where applicable, is, for example, between 0.175 mm and π*D_{S}−N*L_{S} mm (millimetres),

where D_{S} is the bore diameter of the stator.
N is the number of teeth of the stator, and
L_{S} is the width of the teeth of the stator.
for example, less than 8 mm, in particular between 0.5 and 3 mm, being, for example, in the order of 1.5 mm.

The teeth of the stator may have end faces which are directed towards the concave rotor, in particular in the case of an internal rotor. In a variant, in the case of an external rotor, the teeth of the stator may have end faces which are directed towards the convex rotor.

The end faces of the teeth of the stator may, for example, be cylinder portions which may have a radius of curvature corresponding to the distance which separates the peak of the teeth of the rotation axis X of the machine.

The bore D_{S} of the stator, which corresponds to the internal diameter of the stator in the case of an external stator, is, for example, between 20 and 220 mm, preferably between 25 and 160 mm, being, for example, in the order of 110 mm.

The teeth of the stator form a cylinder head of the stator which may be in one piece or in a variant which may be formed by a series of teeth which are connected to each other by bridges of material, or a plurality of separate teeth. In any case, the stator may comprise an external frame which surrounds the cylinder head.

The teeth of the stator may be produced with a stack of magnetic metal sheets which are each covered with an insulating varnish in order to limit the losses as a result of induced current.

In one embodiment, the stator may comprise 18 teeth.

The stator may not comprise any angular offset between the two ends thereof.

Machine

The machine may constitute a generator or a motor.

The rotating electrical machine according to the invention may have an external diameter, for example, between 40 and 280 mm, preferably between 50 and 220 mm, being, for example, in the order of 185 mm. The diameter may, for example, be less than or equal to 240 mm, being in particular between 40 mm and 190 mm.

The power of the machine may be between 0.1 and 15 kW, being, for example, in the order of 0.75 kW, this value being by no means limiting.

The machine may comprise a single internal rotor or, in a variant, a single external rotor or, in another variant, an internal rotor and an external rotor, which are arranged radially at one side and the other of the stator and which are coupled in terms of rotation.

The number of notches per pole and per phase may be a whole number or a fraction.

The number of poles P of the rotor is, for example, between 4 and 40 and the number of teeth S of the stator is, for example, between 6 and 48.

The machine may not be closed.

The invention further relates to a robot comprising a rotating electrical machine as described above for the motorisation thereof.

### BRIEF DESCRIPTION OF THE DRAWINGS

The invention may be better understood from a reading of the following detailed description of non-limiting embodiments thereof and an examination of the appended drawings, in which:

FIG. 1 is a schematic, partial view of a rotating electrical machine according to the invention.

FIG. 1a is a perspective, schematic partial view of the rotor of FIG. 1.

FIG. 2a is a cross section of a permanent magnet of the machine of FIG. 1.

FIG. 2b is a longitudinal section of a permanent magnet of the machine of FIG. 1.

FIG. 3 is a view similar to FIG. 1 of a variant.

FIG. 4 is a schematic, partial view of a variant.

### DETAILED DESCRIPTION

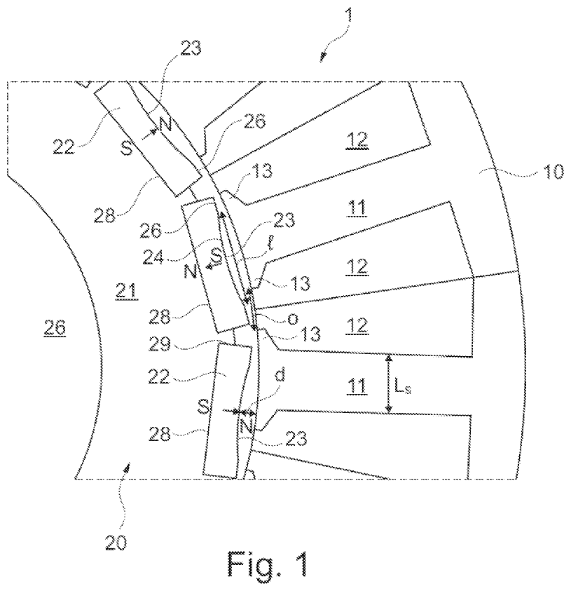

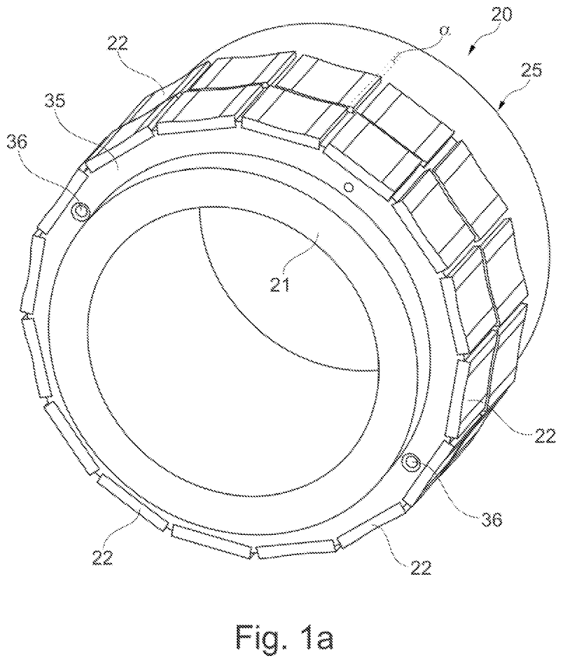

FIGS. 1 and 1a illustrate a rotating electrical machine 1 according to the invention, comprising an external stator 10 and an internal rotor 20 which comprises a rotor mass 25 comprising a shaft 21 and permanent magnets 22 which are arranged on the surface of the rotor mass 25

The stator 10 has in the example described a concentrated winding. The stator 10 comprises teeth 11 which each carry an individual coil 12 which is arranged on the corresponding tooth. The coils 12 are electrically connected to each other so as to be supplied by a three-phase current.

The teeth of the stator comprise pole shoes 13. The opening o of the notches of the stator, measured circumferentially, between the pole shoes 13 is, for example, in the order of 1.5 mm.

The bore of the stator, which corresponds to the internal diameter of the stator, is in the order of 90 mm.

The stator further comprises an external frame which surrounds the cylinder head and which is not illustrated.

On the rotor, the shaft 21 is massive, being hollow at the centre thereof and providing a space 27.

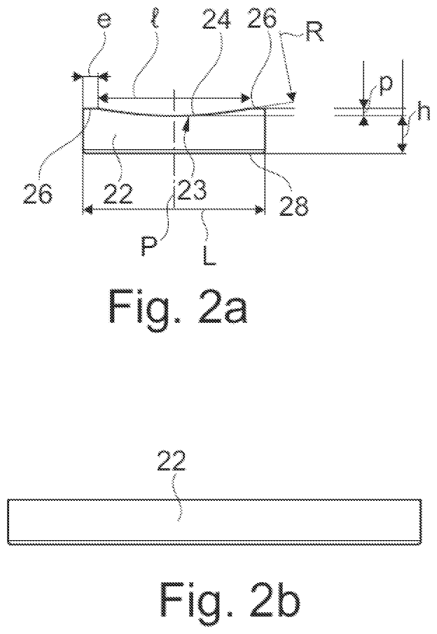

In accordance with the invention and as illustrated in detail in FIGS. 2a and 2b, the permanent magnets 22 of the rotor comprise a face 23 which is directed towards the stator, which is generally of concave form. The face 23 of the magnets directed towards the stator corresponds to the face of the magnets opposite the rotation axis X of the machine.

The concave face 23 of a permanent magnet 22 of the rotor comprises a concave portion 24.

The width l of the concave portion 24, measured perpendicularly to a radius of the rotor, in cross section, is in the order of 9 mm in the example described.

The width L of a permanent magnet 22 of the rotor measured perpendicularly to the rotation axis, in cross section, is in the order of 19 mm.

The greatest width p of the concavity of the concave portion, measured along a radius of the rotor, in cross section is in the order of 0.5 mm.

The greatest depth of the concavity of the concave portion, measured along a radius of the rotor, is in the example described located at the centre of the concave face of the corresponding permanent magnet. The permanent magnet is symmetrical relative to a plane P which intersects it at the centre thereof, this plane passing through the rotation axis of the machine and a radius of the rotor.

The concave portion 24 is in the example described in cross section a circle portion, having a radius R in the order of 20 mm.

The concave portion 24 of the concave face 23 is arranged between two planar lateral portions 26.

The width e of a planar lateral portion measured perpendicularly to a radius of the rotor, in cross section, is in the order of 2 mm.

The concave portion constitutes in the example described approximately 75% of the total width of the corresponding magnet.

The permanent magnets of the rotor have, when the machine is viewed along the rotation axis, a cross section which is generally rectangular with a long side which is orientated perpendicularly to a radius of the machine.

The permanent magnets 22 of the rotor have a thickness h, measured along a radius of the rotor, in cross section, in the order of 3 mm.

A ratio p/h between the greatest depth p of the concavity of the concave portion, measured along a radius of the rotor, and the thickness h of the permanent magnet 22 is in the order of 0.2.

The rotor and the stator provide between them an air gap 30. The air gap has a width, measured along a radius of the machine, in cross section, in the order of 0.9 mm. The width d₀ of the air gap, measured along a radius which extends through the centre of a magnet 22, in cross section, is in the order of 1.5 mm.

The bore of the rotor, which corresponds to the external diameter of the rotor, is in the order of 50 mm.

The permanent magnets 22 of the rotor comprise a fixing face 28 which is opposite the concave face 23, directed towards the stator and, in the example described, of planar form. The planar face is orientated perpendicularly to the radius which extends through the rotation axis and which intersects the corresponding magnet at mid-length.

The permanent magnets 22 are fixed to the rotor mass 25 by means of adhesive bonding in a housing 29 which is provided to this end on the surface thereof. The housing 29 has a planar surface which corresponds to the shape of the fixing face of the magnets.

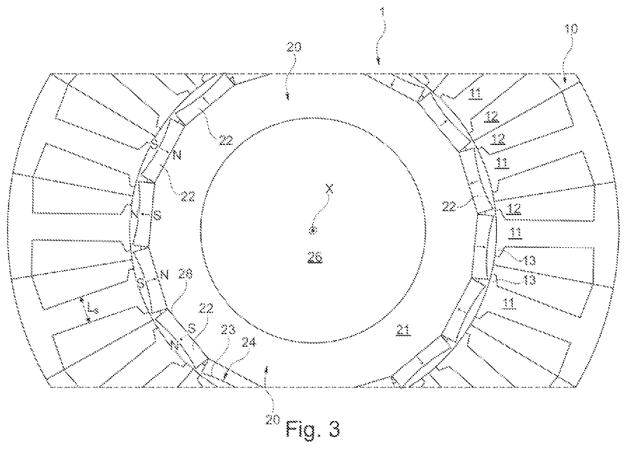

The concave face 23 may comprise one or more concave portions 24 and one or more planar portions 26, as illustrated above, or be completely concave, as illustrated by way of example in FIG. 3.

In this example, in the absence of a planar lateral portion, the concave portion 24 constitutes 100% of the total width of the corresponding magnet.

In accordance with the invention, and as can be seen in FIG. 1a, the permanent magnets 22 of the rotor 20 form poles of the rotor. The permanent magnets of the same pole have an angular offset α between two longitudinal ends of the machine, as illustrated in FIG. 1a.

In the example described, the rotor mass comprises a socket 35 to which the permanent magnets are fixed, for example, by means of adhesive bonding. The socket(s) may be fixed, for example, by means of adhesive bonding, to the shaft 21 of the machine which may be smooth.

The socket 35 may be formed by a stack of metal sheets. The socket 35 may be single, carrying all the permanent magnets of the rotor. In a variant, the rotor mass may comprise a plurality of sockets.

Furthermore, each pole of the rotor comprises two permanent magnets 22 which are offset angularly relative to each other by a specific angle. The permanent magnets are straight, that is to say, not twisted.

The angular offset α between two consecutive magnets of the same pole is in the example described 1.25°. Furthermore, an angular offset between the first magnet and the last magnet of the same pole is in this example 1.25°.

In this manner, the rotor comprises a plurality of circumferential rows of permanent magnets 22, that is to say, two in this example. All the permanent magnets 22 of the same circumferential row are fixed to the same socket 35 mentioned above.

The rotor therefore comprises two assemblies which are each composed of a socket 35 and permanent magnets 22 which are arranged in a circumferential row. The two assemblies may be identical.

In the example described, they are both arranged symmetrically with respect to each other relative to a transverse plane of the machine. Such a configuration enables the angular offset to be produced as a result of the overturning of one assembly relative to the other.

To this end, the socket 35 comprises two through-holes 36 for rods in order to enable the socket(s) 35 to be clamped around the shaft 21 of the machine. The holes 36 are positioned in such a manner that, when a socket 35 is placed symmetrically relative to another socket 35, an angular offset is obtained between the permanent magnets which they carry.

The holes 36 are positioned below and at the centre of the magnet. They are offset relative to each other by substantially 180°. These two holes 36 are not precisely in the axis of the centre of the magnet, but instead offset by an angle equal to half of the angular offset, that is, for example, 0.625°. Each socket being identical, by overturning one of the two sockets by 180° about the axis X, the angular offset is generated between the sockets.

In a variant, it is also possible to fret the sockets without adhesive bonding. The fretting involves heating a socket with a very tight internal diameter in order to expand it and to fit it to the shaft. Another possibility is to machine the housings of the magnets directly onto the shaft.

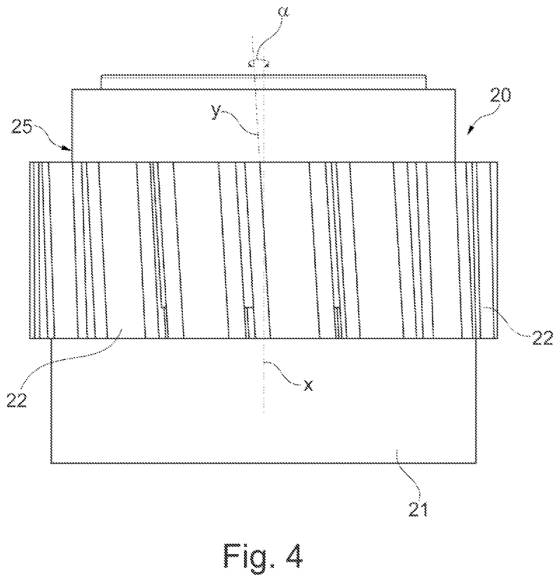

In a variant which is illustrated in FIG. 4, each pole may comprise a twisted permanent magnet 22 which extends along a longitudinal axis Y which is inclined through an angle α relative to the axis X of the machine. In this example, each pole comprises a single twisted magnet, but, in a variant, it may comprise a plurality of them.

In this manner, there is an angular offset a between each of the two longitudinal ends of the permanent magnet 22. The angular offset α between each of the two longitudinal ends of each permanent magnet 22 is, for example, 2.5°.

In the examples considered, the rotor comprises 16 poles and the stator 18 comprises teeth. The scope of the present invention is not exceeded if the number thereof is different.

The invention is not limited to the embodiments which have been described above and the rotor may, for example, comprise a different number of poles and the same applies to the teeth of the stator.

Furthermore, in the example described, the rotor is internal, but it remains within the scope of the present invention if the rotor is external, or if the machine comprises both an internal rotor and an external rotor which are each arranged radially at one side and the other of the stator and which are coupled in terms of rotation.

The machine may be used not only as a motor but also as a generator in order to carry out energy recovery, for example.

The machine according to the invention may have applications other than the motorisation of robots.

1. A rotating electrical machine comprising:
a stator and
a rotor comprising a rotor mass and permanent magnets which are arranged on the surface of the rotor mass, the permanent magnets comprising a face which is directed towards the stator and which is of generally concave form,
the permanent magnets of the rotor forming poles of the rotor, the permanent magnet(s) of a same pole having an angular offset (a) between two longitudinal ends of the machine.

2. The rotating electrical machine according to claim 1, wherein the rotor mass comprises a socket to which the permanent magnets are fixed.

3. The rotating electrical machine according to claim 1, wherein each pole comprises at least one twisted permanent magnet.

4. The rotating electrical machine according to claim 3, wherein the angular offset (α) between each of the two longitudinal ends of the permanent magnet being between 1° and 5°.

5. The rotating electrical machine according to claim 1, wherein each pole comprising a plurality of permanent magnets which are angularly offset relative to each other.

6. The rotating electrical machine according to claim 5, wherein the rotor comprising at least two assemblies composed of a socket and permanent magnets which are fixed to the socket and which are arranged in a circumferential row, the two assemblies being arranged symmetrically with respect to each other relative to a transverse plane of the machine.

7. The rotating electrical machine according to claim 5, wherein the angular offset (α) between two consecutive permanent magnets of the same pole being between 0.8° and 2.5°.

8. The rotating electrical machine according to claim 1, wherein the rotor comprising 16 poles.

9. The rotating electrical machine according to claim 1, wherein the rotor is internal.

10. The rotating electrical machine according to claim 1, wherein a concave face of a permanent magnet of the rotor comprises a concave portion, having a width which is measured perpendicularly relative to a radius of the rotor between 2 and 56 mm.

11. The rotating electrical machine according to claim 10, wherein the greatest depth (p) of the concavity of the concave portion, measured along a radius of the rotor, is between 0.05 and 3 mm.

12. The rotating electrical machine according to claim 10, wherein the concave portion is a circle portion or an ellipse portion in cross section.

13. The rotating electrical machine according to claim 1, wherein the concave portion of a concave face is arranged between two planar lateral portions.

14. The rotating electrical machine according to claim 1, wherein the permanent magnets of the rotor having a thickness (h), measured along a radius of the rotor, between 1.5 and 10 mm.

15. The rotating electrical machine according to claim 1, wherein a ratio (p/h) between the greatest depth of the concavity of the concave portion, measured along a radius of the rotor, and the thickness of a permanent magnet being between 0.01 and 0.9.

16. The rotating electrical machine according to claim 1, wherein the permanent magnets are fixed to the rotor mass of the rotor by means of adhesive bonding.

17. The rotating electrical machine according to claim 1, wherein the permanent magnets comprise a fixing face which is opposite the concave face, directed towards the stator and planar.

18. The rotating electrical machine according to claim 1, the stator having concentrated winding comprising teeth and coils that are arranged on the teeth.
